(19) United States
(12) Patent Application Publication
(10) Pub. No.: US 2024/0343912 A1
(43) Pub. Date: Oct. 17, 2024

(54) PLASTIC WASTE VALORIZATION TO SELF-ADHESIVE SUPER-HYDROPHOBIC FILMS

(71) Applicant: KING FAISAL UNIVERSITY, AL-AHSA (SA)

(72) Inventors: Junaid SALEEM, AL-AHSA (SA); SAFDAR HOSSAIN SK, AL-AHSA (SA); ZUBAIR KHALID BAIG MOGHAL, AL-AHSA (SA); GORDAN MCKAY, AL-AHSA (SA)

(21) Appl. No.: 18/584,983

(22) Filed: Feb. 22, 2024

Related U.S. Application Data
(63) Continuation-in-part of application No. 18/221,072, filed on Jul. 12, 2023, now abandoned.
Application No. 18/221,072 is a division of application No. 18/133,486, filed on Apr. 11, 2023, now abandoned.

(51) Int. Cl. C09D 5/00; B29B 17/02; B29C 39/00; B29C 39/02; B29C 39/04; B29C 39/38; B29K 223/00; C09D 123/06; C09D 123/12

(52) U.S. Cl. CPC C09D 5/00; B29B 17/02; B29C 39/003; B29C 39/025; B29C 39/04; B29C 39/38; C09D 123/06; C09D 123/12; B29B 2017/0203; B29K 2223/0625; B29K 2223/0633; B29K 2223/065; B29K 2223/12; B29K 2909/08; B29K 2995/0093

(57) ABSTRACT

Superhydrophobic films from plastic waste and a fabrication method thereof are provided. Superhydrophobic films with variable thickness, comprising a base and top layer, can be created using semi-crystalline polymers, including virgin, recycled, or waste forms. The fabrication process utilizes 60% of total plastic waste, resulting in films with contact angles between 120° to 160°, tensile strength ranging from 1 MPa to about 70 MPa, and thickness ranging from 20 μm to about 5 mm. Superhydrophobic films may impart protective water-repellent properties against the elements.

The present application is filed as a continuation-in-part of U.S. patent application Ser. No. 18/221,072, filed on Jul. 12, 2023, which application in turn is a divisional of U.S. patent application Ser. No. 18/133,486, filed on Apr. 11, 2023, the contents of each of which are hereby incorporated by reference in their entirety.

### BACKGROUND

### 1. Field

The disclosure of the present patent application relates to self-adhesive super-hydrophobic coatings produced using plastic waste.

### 2. Description of the Related Art

Superhydrophobicity has gained considerable attention in surface science in the past 20 years. Superhydrophobicity is characterized by unique water-repellent properties, combined with a self-cleaning effect. Reference is made to the review article by R. Rioboo, B. Delattre, D. Duvivier, A. Vaillant and J. De Coninck, “Superhydrophobicity and liquid repellency of solutions on polypropylene”, Adv. Colloid. Interfac., 2012, 175, 1-10.

The concept of superhydrophobic coating entails a surface that exhibits a water contact angle exceeding 150° and a sliding angle lower than 5° [1-4]. Apart from their application in water protection, flexible superhydrophobic films also serve as matrices for electromagnetic composites [5-8]. In order to achieve such surfaces, several commonly employed materials include fluoro-polysiloxane and polydimethylsiloxane [9], black iron oxide nanoparticles (NPs) [10], titanium dioxide, and stoichiometric salinization [11][12], composite microspheres consisting of polystyrene and silicon dioxide[13], silicon dioxide combined with epoxy resin [14], fluorinated nanodiamonds [15], silicon dioxide nanoparticles embedded within electro-spun fibrous mats [16], as well as cellulose-based derivatives [17].

While these materials can yield superhydrophobic surfaces, they can also contain fluorinated and/or silane compounds, which increase the overall cost of the material. While utilizing plastic waste may provide a cheaper alternative, producing a free-standing superhydrophobic surface remains a challenge.

There are two approaches in creating hydrophobicity: (a) grafting of a chemical that possesses anti-wetting properties, and (b) creating surface roughness by altering the morphology [18]. In other words, superhydrophobic surfaces are typically created by enhancing nanoscale roughness or incorporating anti-wetting additives like silanes, nanoparticles, or fluorinated compounds. Limited by the availability of nano-structured templates, simple fabrication, flexibility of the material, and cost-effectiveness, the quest to synthesize superhydrophobic films remains challenging.

Despite the fact that polyolefins may be recovered from recycled plastic material, sourcing is relatively limited and/or costly and life cycle requirements tend to impose a reduction in consumption of polyolefin. Thus, there is a need to reduce the consumption of crystallized polymers in the preparation of superhydrophobic surfaces, while not substantially impairing the superhydrophobic properties of the material.

US2010/0316806 discloses anti-frost coatings that form a hydrophilic and hydrophobic composite structure when applied on a substrate, such that the inner layer of the coating is a hydrophilic polymer layer, and the surface layer is a hydrophobic or superhydrophobic polymer layer. As described therein, because of the hydrophobic or superhydrophobic surface, the contact area between water droplets and the coated substrate is reduced and the heat conduction is slow, thereby lengthening the transformation of condensed water drops into frost crystals. Also, owing to the hydrophobicity or superhydrophobicity, water droplets tend to roll off the coated surface, thereby reducing the amount of formed water crystals. Further, the hydrophilic character of the inner layer will adsorb water drops that permeate into the coating and that water will exist in the form of a gel which tends to prevent frost crystal formation. The teaching of the document heavily relies on the synergy between the hygroscopicity of the hydrophilic inner layer and the hydrophobicity or superhydrophobicity of the outer layer.

De Coninck (U.S. 2019/0256716 A1) describes a superhydrophobic coating composition including a solution of crystalline and/or semicrystalline polymers, and of an amorphous hydrophobic matrix polymer in a solvent. Crystalline and/or semicrystalline polymers are dispersed in the matrix of amorphous polymer in the form of microparticles or nanoparticles. De Coninck's disclosure is primarily designed for applying superhydrophobic coatings onto various substrates. These coatings could not be removed from the substrate. The only example (as demonstrated in example 13, paragraphs [0148]-[0152]) in which De Coninck removed the coating from the substrate is the one in which the coating is composed of a combination of pure cardanol epoxy layers and a mixture of cardanol epoxy and polypropylene (PP), with PP constituting 30%, and with the top and bottom layers are made of pure cardanol epoxy. According to his method, superhydrophobic membrane, film, or sheet is prepared by applying multiple layers of coatings—in which epoxy is a major component and PP is a minor component—on to the substrate, and then removing the coating from the substrate by placing the coated substrate into a curing oven and maintained at 60° C. for 16 hours (as demonstrated in example 13, paragraphs [0148] to [0152]).

De Coninck does not teach the process of creating superhydrophobic freestanding films using polyolefin only—such as PP, high-density polyethylene (HDPE), low-density polyethylene (LDPE), linear low-density polyethylene (LLDPE), or their combinations. De Coninck's approach involved the production of multilayered films, with the top and bottom layers always composed of pure cardinal epoxy, while the middle layer or layers comprise a PP-epoxy composite, where PP constituted 30% of the material. Particularly, De Coninck did not employ PP as the sole material for preparing superhydrophobic freestanding coatings or films. Those with ordinary skill in the art would have recognized that epoxy is well-known for its strength and water-repellent properties.

The main theme of De Coninck's disclosure is to prepare a superhydrophobic coating in which a lower amount (around 30%) of semicrystalline polymer such as PP is used. Accordingly, De Coninck does not teach the effects of further drying and/or curing on the final properties of the superhydrophobic films, especially in cases where only polyolefin waste (PP, HDPE, LDPE, LLDPE or their combination) is used. This is likely because, at the time of De Coninck's filing, it was believed that this “further drying and/or curing prior to withdrawal of the coating from the substrate” in cases where only polyolefin waste (PP, HDPE, LDPE, or their combination) is used would decrease the superhydrophobicity of the film due to the presence of oxygen moieties. Further, De Coninck does not teach the required time and temperature of “further drying and/or curing prior to withdrawal of the coating from the substrate”, particularly in cases where only polyolefin waste (PP, HDPE, LDPE, or their combination) is used. Further, De Coninck does not teach a process of removing the ‘coating’ or film from the substrate, especially in cases where only polyolefin waste (PP, HDPE, LDPE, or their combination) is used, and that possess superhydrophobic characteristics (water contact angle from 150° to 160°) and sufficient mechanical strength to be used as a freestanding film. De Coninck does not teach how the tensile strength can be improved as per the end-user requirements. De Coninck does not report the mechanical properties of the peeled off ‘coating’ or film from the substrate.

Hence, there is a need for a process that can generate freestanding superhydrophobic films from semicrystalline polymers, with a specific emphasis on harnessing the potential of polyolefin waste, including PP, HDPE, LDPE and LLDPE. These polyolefins account for a significant 60% of the total plastic waste. This process should have the capability to convert this waste into valuable freestanding superhydrophobic films, all without the necessity of additives like epoxy.

### SUMMARY

The present subject matter is directed to a method for making a superhydrophobic film using recycled material which is recovered from a waste plastic or polymer material derived from post-consumer and/or industrial waste. The method includes depositing a solution of the recycled material on a substrate in multiple layers, removing the solvent, and separating the superhydrophobic film from the substrate. The recycled material comprises one or more of high-density polyethylene (HDPE), low-density polyethylene (LDPE), linear low-density polyethylene (LLDPE), and polypropylene (PP).

In an embodiment, the films prepared according to the presently claimed methods are freestanding and superhydrophobic for use in various applications without the need for an underlying substrate or without adding any composite such as epoxy. In certain embodiments, each layer of the superhydrophobic film can comprise or consist of the polyolefin, i.e., PP, HDPE, LDPE, LLDPE, or a combination thereof, thus making clear no layer in the superhydrophobic film made according to the present methods contains an epoxy component.

In one embodiment, the present subject matter relates to a method of making a freestanding superhydrophobic film, the method comprising:

### Step 1:

dissolving first semi-crystalline polymers in a solvent to form a first solution; pre-heating a solid substrate to a temperature below a boiling point of the solvent; applying the first solution onto the solid substrate using spin casting to obtain a porous blended polymer layer with a fragile structure; and
annealing the porous blended polymer layer with a fragile structure to a temperature above a melting point of the first semi-crystalline polymers to strengthen the porous blended polymer layer's internal structure by closing the porous blended polymer layer's pores and decreasing surface roughness, thereby obtaining a strong non-porous base support layer having a thickness of about 10 μm to about 400 μm; and

### Step 2:

dissolving a second semi-crystalline polymer in the solvent to form a second solution; pre-heating the strong non-porous base support layer to a temperature below a boiling point of the solvent;
applying the second solution onto the strong non-porous base support layer to obtain a top porous layer crosslinked with the strong non-porous base support layer; and peeling off the top porous layer crosslinked with the strong non-porous base support layer to obtain the freestanding superhydrophobic film,
wherein the freestanding superhydrophobic film has a total thickness of about 20 μm to about 800 μm, or about 20 μm to about 1 mm, or about 20 μm to about 5 mm.

In another embodiment, the present subject matter relates to a superhydrophobic film produced according to the present methods.

These and other features of the present subject matter will become readily apparent upon further review of the following specification.

### DETAILED DESCRIPTION OF THE PREFERRED EMBODIMENTS

The following definitions are provided for the purpose of understanding the present subject matter and for construing the appended patent claims.

### Definitions

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

As used herein the term “superhydrophic surface” means a surface having i) a receding static water contact angle (a 50 μl water droplet on a flat surface in an essentially horizontal plane) of more than 135°, preferably more than 140° or more than 145°, more preferably from 145° to 160°, and ii) an advancing static water contact angle of more than 135°, preferably more than 140° or more than 145°, and more preferably from 1450 to 160°, as measured by a Drop Shape Krüss Analyser and corresponding protocol and iii) preferably a water roll-off angle also called sliding angle (dynamic measure) of less than 10°, preferably less than 6°.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

The present subject matter is directed to a method for making a superhydrophobic film using recycled material which is recovered from a waste plastic or polymer material derived from post-consumer and/or industrial waste. The method includes depositing a solution of the recycled material on a substrate in multiple layers, removing the solvent, and separating the superhydrophobic film from the substrate. The recycled material comprises one or more of high-density polyethylene (HDPE), low-density polyethylene (LDPE), linear low-density polyethylene (LLDPE), and polypropylene (PP).

In one embodiment, the present subject matter relates to a method of making a freestanding superhydrophobic film, the method comprising:

### Step 1:

dissolving first semi-crystalline polymers in a solvent to form a first solution; pre-heating a solid substrate to a temperature below a boiling point of the solvent; applying the first solution onto the solid substrate using spin casting to obtain a porous blended polymer layer with a fragile structure; and
annealing the porous blended polymer layer with a fragile structure to a temperature above a melting point of the first semi-crystalline polymers to strengthen the porous blended polymer layer's internal structure by closing the porous blended polymer layer's pores and decreasing surface roughness, thereby obtaining a strong non-porous base support layer having a thickness of about 10 μm to about 400 μm; and

### Step 2:

dissolving a second semi-crystalline polymer in the solvent to form a second solution; pre-heating the strong non-porous base support layer to a temperature below a boiling point of the solvent;
applying the second solution onto the strong non-porous base support layer to obtain a top porous layer crosslinked with the strong non-porous base support layer; and peeling off the top porous layer crosslinked with the strong non-porous base support layer to obtain the freestanding superhydrophobic film,
wherein the freestanding superhydrophobic film has a total thickness of about 20 μm to about 800 μm, or about 20 μm to about 1 mm, or about 20 μm to about 5 mm.

In another embodiment, the present subject matter relates to a method of making a freestanding superhydrophobic film, the method comprising:
dissolving one or more first semi-crystalline polymer(s) in a solvent to form a first clear, hot polymer solution;
pre-heating a solid substrate to a temperature below a boiling point of the solvent;
applying the first clear, hot polymer solution onto the heated solid substrate followed by spin casting for about 30 seconds to about 10 minutes, at a speed of about 300 rpm to about 3500 rpm, followed by annealing to a temperature above a melting point of the one or more first semi-crystalline polymer(s) to obtain a strong, non-porous base support layer;
dissolving one or more second semi-crystalline polymer(s) in the solvent to form a second clear, hot polymer solution;
pre-heating the strong non-porous base support layer to a temperature below a boiling point of the solvent;
applying the second hot, clear polymer solution onto the heated strong non-porous base support layer followed by spin casting for about 30 seconds to about 10 minutes, at a speed of about 300 rpm to about 3500 rpm to obtain a nonporous superhydrophobic top layer on the strong, non-porous base support layer to form a superhydrophobic film; and
peeling off the superhydrophobic film from the solid substrate to obtain the freestanding superhydrophobic film.

In certain embodiments, the polymer material can be a waste polymer material selected from the group consisting of polypropylene (PP), high density polyethylene (HDPE), low-density polyethylene (LDPE), and linear low-density polyethylene (LLDPE). In other embodiments, the first group of plastics comprises the polypropylene (PP), high density polyethylene (HDPE), low-density polyethylene (LDPE), and linear low-density polyethylene (LLDPE) in equal ratios. In one embodiment, the polymer material can be polypropylene (PP), whether isotactic, atactic, syntactic, or amorphous. In further embodiments in this regard, the waste polymer material can be recycled material recovered from post-consumer or industrial waste, or any other recycled plastic waste. In other embodiments, the polymer material used herein can be in virgin, waste, or recycled form.

In one embodiment, the solvent used in the present processes can be selected from the group consisting of p-xylene, m-xylene, o-xylene, an isomeric mixture of xylenes, toluene, decalin, mesitylene, other aromatic hydrocarbons, and mixtures thereof. In an embodiment, the solvent can be an isomeric mixture of xylenes. Other, similar organic solvents may be useful in this regard. The organic solvent can be used to dissolve the polymers under reflux conditions. In this regard, the solvent used in both Step 1 and Step 2 of the present methods can be the same.

In another embodiment, in the present methods, the step of applying the plastic solution onto a solid substrate by spin coating followed by annealing can comprise: a first spin coating step at a first speed for about 20 seconds; a second spin coating step at a second speed which is higher than the first speed for about 120 seconds to obtain a first uniform thin layer and ensure complete removal of the solvent; and heating the first uniform thin layer until it becomes transparent, thereby obtaining the support layer which is nonporous. In this way, all the pores can be closed, and the layer can obtain sufficient strength to be used in all types of applications. This nonporous thin layer can act as a barrier, thereby preventing air from penetrating the surface on which the superhydrophobic film is applied.

In this regard, the first application of the plastic solution to the substrate can be conducted at two speeds, wherein the first speed is about 500 rpm and the second speed is about 2500 rpm. Depending on the desired characteristics of the film, the speeds can vary, for example from about 500 rpm to about 1000 rpm for the first speed and about 2500 rpm to about 3000 rpm for the second speed. If the rpm is increased, the final thickness will be reduced. By way of non-limiting example, if the first speed is increased to 1000 rpm for 20 seconds the initial thickness of the first layer, i.e., the non-porous base support layer, can be about 10 μm. Similarly, if the second speed is increased, the final thickness of the first layer, i.e., the non-porous base support layer, can be about 20 μm.

Further, for the heating step, the heating can be conducted at about 130° C., to create a nonporous thin film having a thickness of about 15 μm, which can be considered as a base layer. In certain embodiments, the base layer can be comprised of only polyolefins including, by way of non-limiting example, one or more of low-density polyethylene (LDPE), high-density polyethylene (HDPE), linear low-density polyethylene (LLDPE), and polypropylene (PP). In this regard, the base layer can be completely epoxy-free.

In another embodiment, in the present methods the step of coating another layer of the plastic solution onto the support layer (base layer) by spin coating comprises: a third spin coating step at a third speed for about 20 seconds; a fourth spin coating step at a fourth speed which is higher than the third speed for about 120 seconds to obtain a uniform thin porous layer and ensure complete removal of the solvent.

Like the first application, the second application of the plastic solution to the base layer, or the support layer, can likewise be conducted at two speeds, wherein the third speed is about 500 rpm, and the fourth speed is about 2500 rpm, which creates a uniform thin film having a thickness of about 28 μm. According to this embodiment, the first nonporous thin layer (base layer) and the second uniform porous thin layer (porous) are taken together to form the superhydrophobic film having a thickness of about 38 μm to about 50 μm. This thickness makes the present compositions possible to be used as self-adhesive stickers and coatings. However, the thickness can vary per the requirements of the end-user or application. For example, where a higher thickness is required, the top hydrophobic layer can have a thickness of about 28 μm to about 30 μm, while the base layer can be increased as required.

Depending on the desired characteristics of the film, the speeds can vary, for example from about 400 rpm to about 700 rpm for the third speed and about 2000 rpm to about 3500 rpm for the fourth speed.

In this regard, in certain embodiments, the first and third speeds may be the same, and the second and fourth speeds may be the same. In other embodiments, the first and third speeds may be different and the second and fourth speeds may be different. Either way, the second and fourth speeds will each always be higher than the first and third speeds.

In certain embodiments, once the coatings are formed, complete removal of the solvent from the coatings can be conducted by subjecting the coatings to vacuum conditions.

In an embodiment, the top layer coated on the base-layer can comprise any of the semi-crystalline polymer(s) such as PP, HDPE, LDPE, and LLDPE.

In certain embodiments, the solid substrate to which the plastic solution is applied is selected from the group consisting of glass, copper, silicon, alumina, and another metal. In one embodiment, the solid substrate can be a glass substrate. To be used in the present spin coating processes, in one non-limiting embodiment, the solid substrate can be placed on a spin coater chuck. During the spin coating process, for the first application of the plastic solution to create the initial film, the solid substrate can be preheated to a temperature of about 120° C. to about 150° C. Once the solid substrate reaches the desired temperature, the hot plastic solution can be poured onto the hot substrate for spin coating. In this regard, the spin coating can occur at various speeds based on the requirements of the final product.

In an embodiment, for the second coating step, the first or base layer on the solid substrate can be heated to maintain a temperature below the boiling point of the solvent. This heating can crosslink the second coating layer with the first layer. The second coating, or top, layer can be a hydrophobic coating comprising polypropylene, high-density polyethylene, low-density polyethylene, or linear low-density polyethylene, individually or in various combinations. For films comprising a top polypropylene layer, they can have a higher hydrophobicity than those comprising a polyethylene. Once the crosslinking is complete, the solvent can be removed by subjecting the hydrophobic coatings to vacuum.

By using multiple coating layers, the mechanical strength of the superhydrophobic coating can be improved. In certain embodiments, the present methods can overcome the shortcomings of spin-coating for semi-crystalline polymers by optimizing their strong dependency on melting temperature and heating time. Accordingly, in certain embodiments, the base layer can comprise one or more separately applied base layers, for example, one, two, three, four, five, or more separately applied base layers, depending on a desired thickness of the base layer. In an embodiment, the base layer can comprise from one to five separately applied base layers.

In further embodiments, the present methods can comprise an additional step of separating the superhydrophobic film from the substrate. According to this embodiment, the superhydrophobic film can be peeled from the substrate using a blade, a tweezer, or forceps without further heating to achieve freestanding superhydrophobic films.

In another embodiment, the methods described herein can effectively utilize about 60% of total plastic waste to prepare superhydrophobic coatings with contact angles ranging from about 120° to about 160°, or about 130° to about 150°.

In another embodiment, the present subject matter relates to a superhydrophobic film produced according to the methods as described herein. In certain embodiments, superhydrophobic films made according to this method can have a thickness of about 43 μm. In other embodiments, the superhydrophobic films made according to the present methods can have a thickness of about 20 μm to about 1 mm. In further embodiments, the superhydrophobic film can be self-adhesive. In further embodiments, the superhydrophobic film comprises a top layer and a bottom layer, the top layer being hydrophobic and comprising one or more of PP, HDPE, LDPE, or LLDPE. In other embodiments in this regard, the top layer can be crosslinked with the bottom layer.

In a further embodiment, the superhydrophobic film can be used for anti-corrosion or anti-wetting applications. In other embodiments, he freestanding superhydrophobic film may be used to impart protective water-repellent properties against the elements.

In addition, the superhydrophobic film can have a contact angle ranging from about 120° to about 160°, or about 130° to 150°. In another embodiment, the superhydrophobic film can have a tensile strength of about 1 MPa to about 70 MPa.

In an additional embodiment, the porous top layer can have a root mean square (RMS) surface roughness from about 50 nm to about 1000 nm.

### EXAMPLES

### Example 1

1 g of polymers comprising polypropylene (PP), high density polyethylene (HDPE), low-density polyethylene (LDPE), and linear low-density polyethylene (LLDPE) in equal ratios was dissolved in 10 ml of xylene under reflux conditions, resulting in solution 1. The reflux temperature ranged from 120-130° C. and was maintained below the boiling temperature of the solvent. Simultaneously, a glass substrate of 25 cm² was taken and heated to 120° C. and placed on a spin coater chuck. Then, the hot polymer solution 1 was poured onto the hot glass substrate. The spin coating was conducted in two steps, the first step involving coating at 500 rpm for 20 seconds followed by 3000 rpm for 120 seconds. The excess polymer and solvent were collected through a drain. After spin coating, the coated glass substrate was detached from the chuck and heated to 130° C. until a nonporous thin film was obtained.

Then, in another round bottomed flask, 1 g of polypropylene (PP) was dissolved in 10 ml xylene under reflux conditions, resulting in solution 2. The base layer produced in the previous step was heated to 120° C., and the polypropylene (PP) solution was poured onto it and spin coated. The spin coating was conducted in two steps, the first step including coating at 500 rpm for 20 seconds followed by 3000 rpm for 120 seconds. Thus, a hydrophobic top layer was formed on the base-layer. The superhydrophobic film was then peeled off using tweezers and separated from the glass substrate. Thus, a free-standing superhydrophobic coated film was produced. This film can be used in combination with adhesive tapes and can be considered as a self-adhesive super-hydrophobic coating.

### Example 2

1 g of polymers comprising polypropylene (PP), high density polyethylene (HDPE), low-density polyethylene (LDPE), and linear low-density polyethylene (LLDPE) in equal ratios was dissolved in 10 ml of xylene under reflux conditions, resulting in solution 1. The reflux temperature ranged from 120-130° C. and was maintained below the boiling temperature of the solvent. Simultaneously, a glass substrate of 25 cm² was taken and heated to 120° C. and placed on a spin coater chuck. Then, the hot polymer solution was poured onto the hot glass substrate. The spin coating was conducted in two steps, the first step involving coating at 500 rpm for 20 seconds followed by 3000 rpm for 120 seconds. The excess polymer and solvent were collected through a drain. After spin coating, the coated glass substrate was detached from the chuck and heated to 130° C. until a nonporous thin film was obtained.

Then, in another round bottomed flask, 1 g of high-density polyethylene (HDPE) was dissolved in 10 ml xylene under reflux conditions, resulting in solution 2. The base layer produced in the previous step was heated to 120° C., and the HDPE solution was poured onto it and spin coated. The spin coating was conducted in two steps, the first step including coating at 500 rpm for 20 seconds followed by 3000 rpm for 120 seconds. Thus, a hydrophobic top layer was formed on the base-layer. The superhydrophobic film was then peeled off using tweezers and separated from the glass substrate. Thus, a free-standing superhydrophobic coated film was produced. This film can be used in combination with adhesive tapes and can be considered as a self-adhesive super-hydrophobic coating.

### Example 3

1 g of polymers comprising polypropylene (PP), high density polyethylene (HDPE), low-density polyethylene (LDPE), and linear low-density polyethylene (LLDPE) in equal ratios was dissolved in 10 ml of xylene under reflux conditions, resulting in solution 1. The reflux temperature ranged from 120-130° C. and was maintained below the boiling temperature of the solvent. Simultaneously, a glass substrate of 25 cm² was taken and heated to 120° C. and placed on a spin coater chuck. Then, the hot polymer solution was poured onto the hot glass substrate. The spin coating was conducted in two steps, the first step involving coating at 500 rpm for 20 seconds followed by 3000 rpm for 120 seconds. The excess polymer and solvent were collected through a drain. After spin coating, the coated glass substrate was detached from the chuck and heated to 130° C. until a nonporous thin film was obtained.

Then, in another round bottomed flask, 1 g of low-density polyethylene (LDPE) was dissolved in 10 ml xylene under reflux conditions, resulting in solution 2. The base layer produced in the previous step was heated to 120° C., and the LDPE solution was poured onto it and spin coated. The spin coating was conducted in two steps, the first step including coating at 500 rpm for 20 seconds followed by 3000 rpm for 120 seconds. Thus, a hydrophobic top layer was formed on the base-layer. The superhydrophobic film was then peeled off using tweezers and separated from the glass substrate. Thus, a free-standing superhydrophobic coated film was produced. This film can be used in combination with adhesive tapes and can be considered as a self-adhesive super-hydrophobic coating.

### Example 4

1 g of polymers comprising polypropylene (PP), high density polyethylene (HDPE), low-density polyethylene (LDPE), and linear low-density polyethylene (LLDPE) in equal ratios was dissolved in 10 ml of xylene under reflux conditions, resulting in solution 1. The reflux temperature ranged from 120-130° C. and was maintained below the boiling temperature of the solvent. Simultaneously, a glass substrate of 25 cm² was taken and heated to 120° C. and placed on a spin coater chuck. Then, the hot polymer solution was poured onto the hot glass substrate. The spin coating was conducted in two steps, the first step involving coating at 500 rpm for 20 seconds followed by 3000 rpm for 120 seconds. The excess polymer and solvent were collected through a drain. After spin coating, the coated glass substrate was detached from the chuck and heated to 130° C. until a nonporous thin film was obtained.

Then, in another round bottomed flask, 1 g of linear low-density polyethylene (LLDPE) was dissolved in 10 ml xylene under reflux conditions, resulting in solution 2. The base layer produced in the previous step was heated to 120° C., and the LLDPE solution was poured onto it and spin coated. The spin coating was conducted in two steps, the first step including coating at 500 rpm for 20 seconds followed by 3000 rpm for 120 seconds. Thus, a hydrophobic top layer was formed on the base-layer. The superhydrophobic film was then peeled off using tweezers and separated from the glass substrate. Thus, a free-standing superhydrophobic coated film was produced. This film can be used in combination with adhesive tapes and can be considered as a self-adhesive super-hydrophobic coating.

### Example 5

1 g of polymers comprising high density polyethylene (HDPE), low-density polyethylene (LDPE), and linear low-density polyethylene (LLDPE) in equal ratios was dissolved in 10 ml of xylene under reflux conditions, resulting in solution 1. The reflux temperature ranged from 120-130° C. and was maintained below the boiling temperature of the solvent. Simultaneously, a glass substrate of 25 cm² was taken and heated to 120° C. and placed on a spin coater chuck. Then, the hot polymer solution was poured onto the hot glass substrate. The spin coating was conducted in two steps, the first step involving coating at 500 rpm for 20 seconds followed by 3000 rpm for 120 seconds. The excess polymer and solvent were collected through a drain. After spin coating, the coated glass substrate was detached from the chuck and heated to 130° C. until a nonporous thin film was obtained.

Then, in another round bottomed flask, 1 g of high-density polyethylene (HDPE) was dissolved in 10 ml xylene under reflux conditions, resulting in solution 2. The base layer produced in the previous step was heated to 120° C., and the HDPE solution was poured onto it and spin coated. The spin coating was conducted in two steps, the first step including coating at 500 rpm for 20 seconds followed by 3000 rpm for 120 seconds. Thus, a hydrophobic top layer was formed on the base-layer. The superhydrophobic film was then peeled off using tweezers and separated from the glass substrate. Thus, a free-standing superhydrophobic coated film was produced. This film can be used in combination with adhesive tapes and can be considered as a self-adhesive super-hydrophobic coating.

### Example 6

1 g of polymers comprising high density polyethylene (HDPE), low-density polyethylene (LDPE), and linear low-density polyethylene (LLDPE) in equal ratios was dissolved in 10 ml of xylene under reflux conditions, resulting in solution 1. The reflux temperature ranged from 120-130° C. and was maintained below the boiling temperature of the solvent. Simultaneously, a glass substrate of 25 cm² was taken and heated to 120° C. and placed on a spin coater chuck. Then, the hot polymer solution was poured onto the hot glass substrate. The spin coating was conducted in two steps, the first step involving coating at 500 rpm for 20 seconds followed by 3000 rpm for 120 seconds. The excess polymer and solvent were collected through a drain. After spin coating, the coated glass substrate was detached from the chuck and heated to 130° C. until a nonporous thin film was obtained.

Then, in another round bottomed flask, 1 g of low-density polyethylene (LDPE) was dissolved in 10 ml xylene under reflux conditions, resulting in solution 2. The base layer produced in the previous step was heated to 120° C., and the LDPE solution was poured onto it and spin coated. The spin coating was conducted in two steps, the first step including coating at 500 rpm for 20 seconds followed by 3000 rpm for 120 seconds. Thus, a hydrophobic top layer was formed on the base-layer. The superhydrophobic film was then peeled off using tweezers and separated from the glass substrate. Thus, a free-standing superhydrophobic coated film was produced. This film can be used in combination with adhesive tapes and can be considered as a self-adhesive super-hydrophobic coating.

### Example 7

1 g of polymers comprising high density polyethylene (HDPE), low-density polyethylene (LDPE), and linear low-density polyethylene (LLDPE) in equal ratios was dissolved in 10 ml of xylene under reflux conditions, resulting in solution 1. The reflux temperature ranged from 120-130° C. and was maintained below the boiling temperature of the solvent. Simultaneously, a glass substrate of 25 cm² was taken and heated to 120° C. and placed on a spin coater chuck. Then, the hot polymer solution was poured onto the hot glass substrate. The spin coating was conducted in two steps, the first step involving coating at 500 rpm for 20 seconds followed by 3000 rpm for 120 seconds. The excess polymer and solvent were collected through a drain. After spin coating, the coated glass substrate was detached from the chuck and heated to 130° C. until a nonporous thin film was obtained.

Then, in another round bottomed flask, 1 g of linear low-density polyethylene (LLDPE) was dissolved in 10 ml xylene under reflux conditions, resulting in solution 2. The base layer produced in the previous step was heated to 120° C., and the LLDPE solution was poured onto it and spin coated. The spin coating was conducted in two steps, the first step including coating at 500 rpm for 20 seconds followed by 3000 rpm for 120 seconds. Thus, a hydrophobic top layer was formed on the base-layer. The superhydrophobic film was then peeled off using tweezers and separated from the glass substrate. Thus, a free-standing superhydrophobic coated film was produced. This film can be used in combination with adhesive tapes and can be considered as a self-adhesive super-hydrophobic coating.

### Example 8

1 g of high density polyethylene (HDPE) was dissolved in 10 ml of xylene under reflux conditions, resulting in solution 1. The reflux temperature ranged from 120-130° C. and was maintained below the boiling temperature of the solvent. Simultaneously, a glass substrate of 25 cm² was taken and heated to 120° C. and placed on a spin coater chuck. Then, the hot polymer solution was poured onto the hot glass substrate. The spin coating was conducted in two steps, the first step involving coating at 500 rpm for 20 seconds followed by 3000 rpm for 120 seconds. The excess polymer and solvent were collected through a drain. After spin coating, the coated glass substrate was detached from the chuck and heated to 130° C. until a nonporous thin film was obtained.

Then, in another round bottomed flask, 1 g of high-density polyethylene (HDPE) was dissolved in 10 ml xylene under reflux conditions, resulting in solution 2. The base layer produced in the previous step was heated to 120° C., and the HDPE solution was poured onto it and spin coated. The spin coating was conducted in two steps, the first step including coating at 500 rpm for 20 seconds followed by 3000 rpm for 120 seconds. Thus, a hydrophobic top layer was formed on the base-layer. The superhydrophobic film was then peeled off using tweezers and separated from the glass substrate. Thus, a free-standing superhydrophobic coated film was produced. This film can be used in combination with adhesive tapes and can be considered as a self-adhesive super-hydrophobic coating.

### Example 9

1 g of low-density polyethylene (LDPE) was dissolved in 10 ml of xylene under reflux conditions, resulting in solution 1. The reflux temperature ranged from 110-120° C. and was maintained below the boiling temperature of the solvent. Simultaneously, a glass substrate of 25 cm² was taken and heated to 120° C. and placed on a spin coater chuck. Then, the hot polymer solution was poured onto the hot glass substrate. The spin coating was conducted in two steps, the first step involving coating at 500 rpm for 20 seconds followed by 3000 rpm for 120 seconds. The excess polymer and solvent were collected through a drain. After spin coating, the coated glass substrate was detached from the chuck and heated to 120° C. until a nonporous thin film was obtained.

Then, in another round bottomed flask, 1 g of low-density polyethylene (LDPE) was dissolved in 10 ml xylene under reflux conditions, resulting in solution 2. The base layer produced in the previous step was heated to 110° C., and the LDPE solution was poured onto it and spin coated. The spin coating was conducted in two steps, the first step including coating at 500 rpm for 20 seconds followed by 3000 rpm for 120 seconds. Thus, a hydrophobic top layer was formed on the base-layer. The superhydrophobic film was then peeled off using tweezers and separated from the glass substrate. Thus, a free-standing superhydrophobic coated film was produced. This film can be used in combination with adhesive tapes and can be considered as a self-adhesive super-hydrophobic coating.

### Example 10

1 g of linear low-density polyethylene (LLDPE) was dissolved in 10 ml of xylene under reflux conditions, resulting in solution 1. The reflux temperature ranged from 120-130° C. and was maintained below the boiling temperature of the solvent. Simultaneously, a glass substrate of 25 cm² was taken and heated to 120° C. and placed on a spin coater chuck. Then, the hot polymer solution was poured onto the hot glass substrate. The spin coating was conducted in two steps, the first step involving coating at 500 rpm for 20 seconds followed by 3000 rpm for 120 seconds. The excess polymer and solvent were collected through a drain. After spin coating, the coated glass substrate was detached from the chuck and heated to 130° C. until a nonporous thin film was obtained.

Then, in another round bottomed flask, 1 g of linear low-density polyethylene (LLDPE) was dissolved in 10 ml xylene under reflux conditions, resulting in solution 2. The base layer produced in the previous step was heated to 120° C., and the LLDPE solution was poured onto it and spin coated. The spin coating was conducted in two steps, the first step including coating at 500 rpm for 20 seconds followed by 3000 rpm for 120 seconds. Thus, a hydrophobic top layer was formed on the base-layer. The superhydrophobic film was then peeled off using tweezers and separated from the glass substrate. Thus, a free-standing superhydrophobic coated film was produced. This film can be used in combination with adhesive tapes and can be considered as a self-adhesive super-hydrophobic coating. [0048] Then, in another round bottomed flask, 1 g of polypropylene (PP) was dissolved in 10 ml xylene under reflux conditions. The base layer produced in the previous step was heated to 120° C., and the polypropylene (PP) solution was poured onto it and spin coated. The spin coating was conducted in two steps, the first step including coating at 500 rpm for 60 seconds followed by 2500 rpm for 60 seconds. Thus, a hydrophobic top layer was formed on the base-layer. The superhydrophobic film was then peeled off using tweezers and separated from the glass substrate. Thus, a free-standing superhydrophobic coated film was produced. This film can be used in combination with adhesive tapes and can be considered as a self-adhesive super-hydrophobic coating.

It is to be understood that the super-hydrophobic coatings are not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

### REFERENCES

ADDIN Mendeley Bibliography CSL_BIBLIOGRAPHY [1] X. H. Lang, T. Y. Zhu, L. Zou, K. Prakashan, Z. X. Zhang, Fabrication and characterization of polypropylene aerogel material and aerogel coated hybrid materials for oil-water separation applications, Prog. Org. Coatings. 137 (2019) 105370. https://doi.org/10.1016/j.porgcoat.2019.105370.
[2] N. B. Nguyen, N. H. Ly, H. N. Tran, S. J. Son, S. Joo, Y. Vasseghian, S. M. Osman, R. Luque, Transparent Oil-Water Separating Spiky SiO2 Nanoparticle Supramolecular Polymer Superhydrophobic Coatings, Small Methods. 7 (2023) 2201257.
[3] H. Ye, L. Zhu, W. Li, H. Liu, H. Chen, Simple spray deposition of a water-based superhydrophobic coating with high stability for flexible applications, J. Mater. Chem. A. 5 (2017) 9882-9890.
[4] J. Saleem, S. Safdar Hossain, Z. K. B. Moghal, G. McKay, Method to prepare superhydrophobic sheets from virgin and waste polypropylene, U. S. patent Ser. No. 11/840,609, 2023. https://www.freepatentsonline.com/11840609.html.
[5] J. Luo, L. Huo, L. Wang, X. Huang, J. Li, Z. Guo, Q. Gao, M. Hu, H. Xue, J. Gao, Superhydrophobic and multi-responsive fabric composite with excellent electro-photo-thermal effect and electromagnetic interference shielding performance, Chem. Eng. J. 391 (2020) 123537. https://doi.org/10.1016/j.cej.2019.123537.
[6] Y. Hao, Z. Leng, C. Yu, P. Xie, S. Meng, L. Zhou, Y. Li, G. Liang, X. Li, C. Liu, Ultra-lightweight hollow bowl-like carbon as microwave absorber owning broad band and low filler loading, Carbon N. Y. 212 (2023) 118156. https://doi.org/10.1016/j.carbon.2023.118156.
[7] G. Fan, Z. Wang, K. Sun, Y. Liu, R. Fan, Doped ceramics of indium oxides for negative permittivity materials in MHz-kHz frequency regions, J. Mater. Sci. Technol. 61 (2021) 125-131. https://doi.org/10.1016/j.jmst.2020.06.013.
[8] G. Fan, Z. Wang, H. Ren, Y. Liu, R. Fan, Dielectric dispersion of copper/rutile cermets: Dielectric resonance, relaxation, and plasma oscillation, Scr. Mater. 190 (2021) 1-6. https://doi.org/10.1016/j.scriptamat.2020.08.027.
[9] S. Zhou, X. Ding, L. Wu, Fabrication of ambient-curable superhydrophobic fluoropolysiloxane/TiO2 nanocomposite coatings with good mechanical properties and durability, Prog. Org. Coatings. 76 (2013) 563-570.
[10] B. Wu, X. Cui, H. Jiang, N. Wu, C. Peng, Z. Hu, X. Liang, Y. Yan, J. Huang, D. Li, A superhydrophobic coating harvesting mechanical robustness, passive anti-icing and active de-icing performances, J. Colloid Interface Sci. 590 (2021) 301-310.
[11] L. M. Qin, Y. Chu, X. Zhou, Q. M. Pan, Fast healable superhydrophobic material, ACS Appl Mater Interfaces 11: 29388-29395, (2019).
[12] L. Zhang, A. G. Zhou, B. R. Sun, K. S. Chen, H.-Z. Yu, Functional and versatile superhydrophobic coatings via stoichiometric silanization, Nat. Commun. 12 (2021) 982.
[13] L. Xu, H. Jin, D. Wu, B. Liu, M. Zhang, Superhydrophobic polystyrene coating based on phase separation of raspberry structure particle, Colloid Polym. Sci. 299 (2021) 1695-1702.
[14] Z. Wang, X. Gao, G. Wen, P. Tian, L. Zhong, X. Gou, Z. Guo, Robust silicon dioxide@ epoxy resin micronanosheet superhydrophobic omnipotent protective coating for applications, Colloids Surfaces A Physicochem. Eng. Asp. 550 (2018) 9-19.
[15] G. Zhang, Q. Xie, J. Chi, Y. Chen, H. Zheng, C. Ma, G. Zhang, Tree root-inspired robust superhydrophobic coatings with high permeation for porous structures, Iscience. 24 (2021) 103197.
[16] D.-E. Lee, E.-Y. Choi, H.-J. Yang, A. S. N. Murthy, T. Singh, J.-M. Lim, J. Im, Highly stretchable superhydrophobic surface by silica nanoparticle embedded electrospun fibrous mat, J. Colloid Interface Sci. 555 (2019) 532-540.
[17] Y. Wu, M. Zhao, Z. Guo, Robust, heat-resistant and multifunctional superhydrophobic coating of carbon microflowers with molybdenum trioxide nanoparticles, J. Colloid Interface Sci. 506 (2017) 649-658.
[18] H. Y. Erbil, A. L. Demirel, Y. Avci, O. Mert, Transformation of a Simple Plastic into a Superhydrophobic Surface, Science (80-.). 299 (2003) 1377-1380. https://doi.org/10.1126/science.1078365.

1. A freestanding superhydrophobic film comprising: a nonporous base layer comprising first semi-crystalline polymer(s), and a porous top layer comprising second semi-crystalline polymer(s), wherein the superhydrophobic film has a total thickness of 20 μm to 1 mm.

2. The freestanding superhydrophobic film of claim 1, wherein the first semi-crystalline polymer(s) and the second semi-crystalline polymer(s) each separately comprise one or more of polypropylene (PP), high density polyethylene (HDPE), low-density polyethylene (LDPE), and linear low-density polyethylene (LLDPE), in virgin, waste, or recycled form.

3. The freestanding superhydrophobic film of claim 1, wherein the nonporous base layer comprises first semi-crystalline polymer(s) comprising a combination of PP, HDPE, LDPE, and LLDPE, and the porous top layer comprises second semi-crystalline polymer(s) comprising a combination of PP, HDPE, LDPE, and LLDPE.

4. The freestanding superhydrophobic film of claim 1, wherein the nonporous base layer comprises first semi-crystalline polymer(s) comprising a combination of PP, HDPE, LDPE, and LLDPE, and the porous top layer comprises second semi-crystalline polymer(s) comprising HDPE.

5. The freestanding superhydrophobic film of claim 1, wherein the nonporous base layer comprises first semi-crystalline polymer(s) comprising a combination of PP, HDPE, LDPE, and LLDPE, and the porous top layer comprises second semi-crystalline polymer(s) comprising PP.

6. The freestanding superhydrophobic film of claim 1, wherein the nonporous base layer comprises first semi-crystalline polymer(s) comprising a combination of PP, HDPE, LDPE, and LLDPE, and the porous top layer comprises second semi-crystalline polymer(s) comprising LDPE.

7. The freestanding superhydrophobic film of claim 1, wherein the nonporous base layer comprises first semi-crystalline polymer(s) comprising a combination of PP, HDPE, LDPE, and LLDPE, and the porous top layer comprises second semi-crystalline polymer(s) comprising LLDPE.

8. The freestanding superhydrophobic film of claim 1, wherein the nonporous base layer comprises first semi-crystalline polymer(s) comprising HDPE, and the porous top layer comprises second semi-crystalline polymer(s) comprising HDPE.

9. The freestanding superhydrophobic film of claim 1, wherein the nonporous base layer comprises first semi-crystalline polymer(s) comprising LDPE, and the porous top layer comprises second semi-crystalline polymer(s) comprising LDPE.

10. The freestanding superhydrophobic film of claim 1, wherein the nonporous base layer comprises first semi-crystalline polymer(s) comprising LLDPE, and the porous top layer comprises second semi-crystalline polymer(s) comprising LLDPE.

11. The freestanding superhydrophobic film of claim 1, wherein the nonporous base layer comprises first semi-crystalline polymer(s) comprising a combination of HDPE, LDPE, and LLDPE, and the porous top layer comprises second semi-crystalline polymer(s) comprising a combination of HDPE, LDPE, and LLDPE.

12. The freestanding superhydrophobic film of claim 1, wherein the nonporous base layer comprises first semi-crystalline polymer(s) comprising a combination of HDPE, LDPE, and LLDPE, and the porous top layer comprises second semi-crystalline polymer(s) comprising a HDPE.

13. The freestanding superhydrophobic film of claim 1, wherein the nonporous base layer comprises first semi-crystalline polymer(s) comprising a combination of HDPE, LDPE, and LLDPE, and the porous top layer comprises second semi-crystalline polymer(s) comprising a LDPE.

14. The freestanding superhydrophobic film of claim 1, wherein the nonporous base layer comprises first semi-crystalline polymer(s) comprising a combination of HDPE, LDPE, and LLDPE, and the porous top layer comprises second semi-crystalline polymer(s) comprising a LLDPE.

15. The freestanding superhydrophobic film of claim 1, wherein the top porous layer comprises root mean square (RMS) surface roughness from 50 to 1000 nm.

16. The freestanding superhydrophobic film of claim 1, wherein the top porous layer of the superhydrophobic film has a water contact angle ranging from about 120° to about 160°.

17. The freestanding superhydrophobic film of claim 1, wherein the superhydrophobic film is self-adhesive, and can be used for anti-corrosion or anti-wetting applications.

18. The freestanding superhydrophobic film of claim 1 wherein the film has a tensile strength of about 1 MPa to about 70 MPa.

19. The superhydrophobic film of claim 1, wherein the base layer comprises from one to five separately applied base layers.

20. The freestanding superhydrophobic film of claim 1 produced according to a method comprising:
dissolving first semi-crystalline polymer(s) individually or in combination in a solvent to form a clear hot polymer solution 1;
pre-heating a solid substrate to a temperature below a boiling point of the solvent;
applying the clear hot polymer solution 1 onto the heated solid substrate followed by spin casting for a time in the range of 30 seconds to 10 minutes, at a speed ranging from 300 to 3500 rpm, followed by annealing to a temperature above a melting point of the polymer to obtain a nonporous base layer;
dissolving second semi-crystalline polymer(s) individual or in combination in a solvent to form a clear hot polymer solution 2; and
applying the hot polymer solution 2 on to the nonporous heated base layer followed by spin casting for a time in the range of 30 seconds to 10 minutes, at a speed ranging from 300 to 3500 rpm to obtain a nonporous superhydrophobic top layer followed by peeling of the superhydrophobic film from the solid substrate.
